(19) United States
(12) Patent Application Publication
(10) Pub. No.: US 2004/0255498 A1
(43) Pub. Date: Dec. 23, 2004

(54) Display device

(76) Inventor: Russell Pointon, Staffordshire (GB)

Correspondence Address: STITES & HARBISON, PLLC, 400 W MARKET ST, SUITE 1800, LOUISVILLE, KY, 40202-3352, US

(21) Appl. No.: 10/488,775

(22) PCT Filed: Sep. 6, 2002
(86) PCT No.: PCT/GB02/04092

(30) Foreign Application Priority Data
Sep. 6, 2001 (GB) 0121584.7

(51) Int. Cl. G09F 21/02

(52) U.S. Cl. 40/586

(57) ABSTRACT

A display device has a planar element (1) having a face adapted to carry for display purposes an image or images, the planar element (1) comprising a tab formed of a flexible or resilient material and being adapted to be fastened by a tie (2) on a part of a human body such as the leg so that said face is visible, the material being sufficiently stiff to ensure that the face remains substantially flat enough for the images to remain viewable during normal movement of the body and normal external forces.

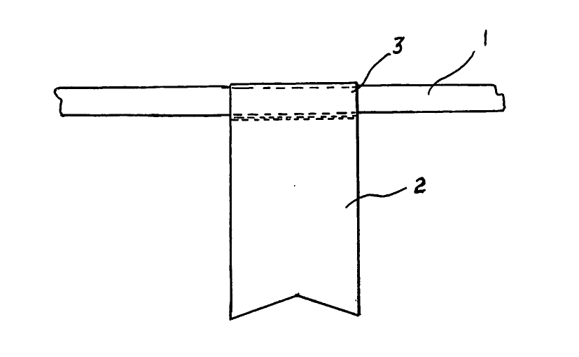

This invention relates to a display device, and particularly but not exclusively, to a display device which is adapted to be worn by a person to indicate allegiance to a particular team, organisation, person or product.

In recent times, it has become popular for spectators at a sporting event to wear clothing or hats, or to carry flags, to indicate their allegiance to one side or one individual taking part in the event. In particular, it has become very popular for football supporters to wear a shirt of their team colours. Frequently, these team shirts carry the number and name of the wearer's favourite player, to show allegiance to and support for a particular player in the team. This can lead to problems if the particular player is dropped or transferred, in which case the shirt is, effectively, unwearable. A further problem arises with what is known as away strip. All teams have an alternative colour which they must use when playing away from home against a team whose basic colour is the same or similar as their own. It is therefore necessary for the supporter to purchase two shirts, one of each colour.

These problems are exacerbated when supporting a national football team, particularly a team taking part in a tournament such as the World Cup, where the team for each match is chosen from a relatively large pool of players. It is clearly not practical for supporters to purchase a shirt bearing the name and/or number of every player in the pool or even a significant number of the players, to guarantee that they have an appropriate shirt for the particular game. It is also not unknown for spectators to switch their allegiance to another team if their own favourite team is knocked out of the competition. Again, it is not practical to have a shirt for all such possibilities. The present invention seeks to provide an alternative manner of showing allegiance to a particular team, participant or product, in a practical, cost effective way.

According to the present invention there is provided a display device including, a planar element having a face adapted to carry for display purposes an image or images, the planar element being secured to or being adapted to be connected to mounting means by which the device is adapted to be supported on a part of a human body so that said face is visible, the planar element being formed of a flexible or resilient material, the device having means to ensure that the face remains substantially flat enough for the images to remain viewable during normal movement of the body and normal external forces.

In a preferred embodiment, the material of the planar element is inherently of sufficient stiffness to lie against the body in use, but is not so stiff as to cause injury if another person collides with the person wearing the device.

In an alternative embodiment, the device may include securing means spaced from said mounting means which serves to secure the planar element to the body at a location spaced from the mounting means. Preferably, the securing means is adapted to secure the planar element to an item of the wearer's clothes, such as socks, and to achieve this may have a strip of engaging means such as VELCRO (a registered trademark) secured thereto. The mounting means may also comprise a strip of said engaging means.

A preferred embodiment of the present invention will now be described by way of example with reference to the accompanying drawing which shows a display device in the form of a tab adapted to be fastened round the leg. This embodiment of the device is intended for use by football spectators and players.

The display device comprises a tab consisting of a rectangular planar element 1 which is mounted on a tie 2 by which the planar element is secured round the upper part of the lower leg by tying a knot. The tie 2 may also support the socks of the wearer. The tie is made of a rigid stretch tape which moves with muscle expansion and thus does not restrict blood circulation. The stretch in the tie is achieved by heat compaction of the material and the amount of wefts in the tie. The planar element 1 has an outer face which is designed to carry an image or images for display purposes.

The planar element 1 is formed of a flexible or resilient material such as polyester which is sufficiently stiff or is treated to be sufficiently stiff to ensure that, in normal circumstances such as normal movement or normal external forces such as the wind, it lies against the leg of the wearer in a sufficiently flat manner that the images remain viewable at all times, but is not so stiff as to cause injury if another person collides with the wearer. In this way, the device may be worn by a player as well as spectators. At its upper end as shown in the drawing, the material of the element is turned over on itself and stitched to provide a sleeve 3 through which the tie1 is passed to secure the two components together. In an alternative form, the tie may be stitched to the tab. In another form, the tie is formed of a band of resilient material to form a garter.

In an alternative embodiment, the tab may include at its end remote from the sleeve, by which it is secured to the tie, an additional fastening means to hold the tab against the clothing of the wearer. Preferably, this is in the form of a flexible engaging means such as VELCRO (a registered trademark), but may be in the form of a second tie or garter or a press stud fastener.

Although this embodiment is described as being suitable for attaching to the lower leg of a person, it will be understood that it may be attached to other parts of the body such as the upper arm or may be in the form of a bandana to be worn round the head with the tab hanging down the back, or even down the front of the face over the nose. In this form, it is envisaged that the tie would be resilient and may also incorporate a further image or images.

The display face of this embodiment is substantially rectangular with a chevron cut in its lower edge, but it will be understood that the shape of the tab may be varied to suit particular requirements. For example, a tab for supporters of, or players in, the Irish football team may be shaped like a Shamrock leaf. A tab advertising Coca-Cola or an event sponsored by this organisation may be shaped like the Coke bottle (a registered trademark). When the tab is intended to be worn over the nose, it may be shaped and coloured like a nose guard of a medieval suit of armour. Alternative forms of cut at the lower edge may be a swallow tail chevron, an arrow head, a straight or round cut. The tab may be double sided so that it has, for example, a team's home colour on one side and their away colour on the other. This enables one tab to carry two sets of information, such as adverts or player's numbers. The tab may also be impregnated with a perfume or fragrance to serve for example as an air freshener.

1-11. (cancelled).

12. A method comprising:
sampling a physiological characteristic of a subject;
determining a measure of said physiological characteristic; and
determining if said subject is in a state of physiological coherency based on said measure, wherein said state is characterized by at least one of a sine-wave-shaped heart rhythm pattern and an increased synchronization between two or more oscillatory systems of said subject.

13. The method of claim 12, wherein determining the measure comprises determining the measure of said physiological characteristic where said physiological characteristic comprises heart rate variability, respiration patterns, blood pressure rhythms and a factor derived from ECG-R wave amplitudes.

14. The method of claim 12, wherein determining the measure comprises determining the measure of said physiological characteristic, said measure being expressed in one of the following: a frequency domain, a time domain, a period analysis and a template match.

15. The method of claim 12, wherein said oscillatory systems are selected from the group consisting of: heart rhythms, respiratory rhythms and blood pressure oscillations, ECG R-wave amplitude, pulse wave, impedance measures and vascular responses.

16. The method of claim 12 wherein said state of physiological coherency is further characterized by a state of entrainment between two or more of said subject's heart rhythms, respiration rhythms and blood pressure rhythms.

17. The method of claim 12 wherein said state of physiological coherency is further characterized by increased positive emotions in said subject.

18. The method of claim 12, wherein determining if said subject is in a state of physiological coherency comprises comparing said measure to a physiological coherency range, wherein said physiological coherency range is expressed in the frequency range and is between 0.03125 Hertz and 0.234 Hertz.

19. The method of claim 18, wherein said coherency range includes a resonance frequency of said physiological characteristic.

20. The method of claim 12 wherein said measure is a pattern usable to determine an emotional state of said subject.

21. The method of claim 12 wherein said state of physiological coherency comprises having one of a phase and frequency lock between said two or more oscillatory systems of said subject.

22. The method of claim 12 wherein determining if said subject is in a state of physiological coherency comprises comparing said measure to a physiological coherency range, and the method further comprises providing said subject with feedback based on said comparing.

23. The method of claim 22 wherein said feedback causes said subject to move closer to said state of physiological coherency.

24. The method of claim 12 further comprising:
sampling the physiological characteristic from each of a plurality of subjects;
determining a group measure from said sampling of the physiological characteristic from each of said plurality of subjects; and
determining if said plurality of subjects are in the state of physiological coherency based on said group measure.

25. The method of claim 24 wherein determining if said plurality of subjects are in the state of physiological coherency comprises comparing said group measure to a physiological coherency range, and the method further comprises providing said plurality of subjects with feedback based on said comparing.

26. The method of claim 25 wherein said feedback causes said plurality of subjects to move closer to said state of physiological coherency.

27. A system comprising:
sampling means adapted to sample a physiological characteristic of a subject; and,
a processor coupled to the sampling means, said processor to, determine a measure of said physiological characteristic, and
determine if said subject is in a state of physiological coherency based on said measure, wherein said state is characterized by at least one of a sine-wave-shaped heart rhythm pattern, and an increased synchronization between two or more oscillatory systems of said subject.

28. The system of claim 27 wherein said physiological characteristic comprises heart rate variability rhythm, respiration patterns, blood pressure rhythms and a factor derived from ECG-R wave amplitudes.

29. The system of claim 27 wherein said measure is expressed in one of: a frequency domain, a time domain, a period analysis and a template match.

30. The system of claim 27 wherein said oscillatory systems are selected from the group consisting of heart rhythms, respiratory rhythms and blood pressure oscillations, ECG R-wave amplitude—pulse wave, impedance measures, vascular responses.

31. The system of claim 27 wherein said state of physiological coherency is further characterized by a state of entrainment between two or more of said subject's heart rhythms, blood pressure rhythms and respiration rhythms.

32. The system of claim 27 wherein said state of physiological coherency is further characterized by increased positive emotions in said subject.

33. The system of claim 27 wherein to determine if said subject is in a state of physiological coherency, the processor is further to compare said measure to a physiological coherency range, wherein said physiological coherency range is expressed in the frequency range and is between 0.03125 Hertz and 0.234 Hertz.

34. The system of claim 33, wherein said coherency range includes a resonance frequency of said physiological characteristic.

35. The system of claim 27 wherein said measure is a pattern usable to determine an emotional state of said subject.

36. The system of claim 27 wherein said state of physiological coherency comprises having one of a phase and frequency lock between said two or more oscillatory systems of said subject.

37. The system of claim 27 wherein to determine if said subject is in a state of physiological coherency, said processor is to compare said measure to a physiological coherency range, and wherein the processor is further to provide said subject with feedback based on a result of comparing said measure to the physiological coherency range.

38. The system of claim 37 wherein said feedback causes said subject to enter said state of physiological coherency.

39. The system of claim 27 wherein the sampling means is further adapted to sample the physiological characteristic from each of a plurality of subjects, and wherein the processor is further to,
determine a group measure from said sampling of the physiological characteristic from each of said plurality of subjects, and
determine if said plurality of subjects are in the state of physiological coherency based on said group measure.

40. The system of claim 39 wherein to determine if said subject is in a state of physiological coherency, said processor is to compare said group measure to a physiological coherency range, and wherein the processor is further to provide said plurality of subjects with feedback based on a result of comparing the group measure to the physiological coherency range.

41. The system of claim 40, wherein said feedback causes said plurality of subjects to move closer to said state of physiological coherency.
